(19) United States
(12) Patent Application Publication
(10) Pub. No.: US 2025/0356755 A1
(43) Pub. Date: Nov. 20, 2025

(54) TRAFFIC SIGNAL SYSTEM

(71) Applicant: Woncheol OH, Sejong-si (KR)

(72) Inventor: Woncheol OH, Sejong-si (KR)

(21) Appl. No.: 18/678,007

(22) Filed: May 30, 2024

(30) Foreign Application Priority Data
May 17, 2024 (KR) 10-2024-0064246

(51) Int. Cl. G08G 1/07; G08G 1/01; G08G 1/095

(52) U.S. Cl. CPC G08G 1/07; G08G 1/0133; G08G 1/095

(57) ABSTRACT

The present invention provides a novel traffic signal system that can prevent traffic accidents and safety accidents that may occur due to failure to see traffic lights.

### TECHNICAL FIELD

The present invention relates to a traffic signal system, and more particularly, to a traffic signal system that improves the visibility of traffic lights.

### BACKGROUND ART

Generally, traffic lights are devices installed at intersections, road crossings, etc. to allow vehicles and pedestrians to drive, walk, and stop. This traffic light can display signals such as green, red and direction and is composed of a plurality of LEDs and displays signals for driving, walking, and stopping through colors.

However, when a pedestrian or driver looks at the traffic lights, it may be difficult to see the traffic light accurately if the sun is shining or a light exists in front of them. This is a case in which the traffic light is covered by the sun or light, and this phenomenon occurs because the traffic light area is narrow. Due to this, there is a problem that traffic accidents and safety accidents may occur.

As a prior art patent relating to the traffic signal system, Korean Patent No. 10-2614255 discloses a system comprising: a camera for acquiring traffic information and road surface condition information, and a traffic information sign board 70 that displays variable display information in response to traffic conditions, weather conditions, and display information by time of day.

Korean Patent No. 10-2604315 discloses a wireless transmission/reception device of pedestrian-operated traffic signal controller comprising: a signal operation unit that controls the lighting of traffic lights by arbitrarily manipulating the green signal lighting time or the additional pedestrian green signal turning off time, a traffic signal controller that is networked with a remote traffic control center, and a wireless push button switch that is installed at a road intersection and generates a walking signal from pedestrians.

Korean Patent No. 10-2564695, which is the applicant's earlier patent, discloses a traffic signal system comprising: a traffic light unit that includes a traffic light consisting of a plurality of LEDs that display signals for vehicle operation, a traffic light support body that supports the traffic light, and a signal auxiliary lighting unit that is disposed in a boundary edge area of the traffic light support body and outputs a plurality of colored lights; and a control unit that controls a plurality of LEDs to turn on in response to signal control signals for traffic lights and controls the signal auxiliary lighting unit so as to output the same color as the traffic light.

The present invention was designed to provide a system that further improve these prior patents, is easily visible to vehicle drivers and pedestrians, makes it easy to understand waiting times at traffic lights, and accurately informs road and section information according to the travelling direction of the vehicle.

### DETAILED DESCRIPTION OF THE INVENTION

### Technical Problem

Therefore, it is an object of the present invention to provide a traffic signal system capable of preventing traffic accidents and safety accidents that may occur due to failure to see traffic lights.

### Technical Solution

In order to achieve the above object, according to the present invention, there is provided a traffic signal system comprising: a traffic light unit that includes a traffic light consisting of a plurality of LEDs that display signals for vehicle operation, a traffic light support body that supports the traffic light, and a signal auxiliary lighting unit that is disposed in a boundary edge area of the traffic light support body and outputs a plurality of colored lights; and a control unit that controls a plurality of LEDs to turn on in response to signal control signals for traffic lights and controls the signal auxiliary lighting unit so as to output the same color as the traffic light, wherein the LED mounted on an upper border or a lower border of the traffic light support body is configured to light up and display a predetermined guide mark, wherein the control unit stores control setting information including a display time for the traffic light, and lights up a guide mark on the traffic light support body in response to the signal display time of the control setting information if the traffic light is turned on, the control unit controls so that: if a green traffic light emits, all of the guide marks light up by arranging square or circular shapes in a line, and the number of lighting of the square or circular shapes decreases as the display time decreases, and if a left turn signal light emits, all of the guide marks light up by arranging arrow shapes with the vertex on the left in a line, and the number of lighting of the arrow shapes decreases as the display time decreases.

The traffic light further comprises a right turn signal light, and the control unit may control so that when the right turn signal light emits, all of the guide marks light up by arranging arrow shapes with the vertex on the right side in a line, and the number of lighting of the arrow shapes decreases as the display time decreases.

The control unit may not start lighting the right turn signal light and the LED of the traffic light auxiliary lighting unit, if the presence of a passerby in a crosswalk area is detected, or if it is received through a communication unit that another traffic light at the right turn intersection has converted to a green traffic light.

A road information guide unit is further included on an upper side or a lower side of the traffic light auxiliary lighting unit, wherein the road information guide unit may include a road name address guide unit and a road condition notification unit.

The road name address guide unit displays a road name for a straight road, a road name when driving on the left, and a road name when driving on the right, wherein the road name may be a road name under the Korean Road Traffic Act of “Road”, “Ro”, or “Gil”.

The road name address guide unit may further display buildings included in the road name address of the straight, left, or right driving section.

The road condition notification unit is installed adjacent to each road name address guide unit, so that when going straight, turning left, or turning right, it is displayed in text whether the section of the corresponding road name address is under “normal,” “slightly delayed,” or “congested” conditions, and the control unit receives road traffic conditions in real time through the communication unit the traffic signal system and may display congestion information.

### Advantageous Effects

According to the present invention, the traffic light auxiliary lighting unit is installed in the border edge area of the traffic light support body to allow the color of the signal auxiliary lighting unit to be output similarly to the color of the traffic light, thereby serving to prevent it from being covered by sun or light, improve visibility, prevent traffic accidents and safety accidents, and finally improve user safety.

In addition, while visibility being improved by the signal auxiliary lighting unit, the remaining time of the signal is displayed or a specific mark indicating the driving direction is displayed, and thus the user can see the remaining time and drive and walk safely, and the visibility of users can be further improved by changing the color, size, or number of marks of the remaining time displayed.

Further, when the remaining time changes, the signal auxiliary lighting unit can also blink to increase visibility, and the light intensity of the signal auxiliary lighting unit may be set to be stronger than the light intensity of the traffic light, thereby further increasing the visibility of the user who sees it.

Further, by adding traffic lights that improve visibility not only for left turns but also for right turns, it is possible to improve safety and more effectively display the road name address already in use in daily life and the corresponding road information.

### BRIEF DESCRIPTION OF THE DRAWINGS

FIG. 1 is an exemplary diagram of a traffic signal system according to the present invention.

FIGS. 2A-2B are exemplary diagram of an embodiment of the signal auxiliary lighting unit.

FIGS. 3A-3B are exemplary diagram of changing the color and size of the signal auxiliary lighting unit depending on the remaining time.

FIGS. 4A-4C are exemplary operation diagram of the signal auxiliary lighting unit in response to the remaining time change.

FIG. 5 is a control block diagram of the traffic signal system.

FIGS. 6A-6C are diagram showing in chronological order that the traffic light auxiliary lighting unit displays a square-shaped mark.

FIGS. 7A-7B are diagram illustrating an operation when a right turn signal light is further included in addition to the embodiment of FIGS. 6A-6C.

FIGS. 8A-8B are diagram in which, in the same right turn signal light as in FIGS. 7A-7B, the left turn signal light is placed on the leftmost side to make it easier to understand, and an arrow-shaped mark is displayed.

FIG. 9 is a diagram showing that the traffic light unit further includes a road information guide unit on an upper side of the traffic light auxiliary lighting unit according to another embodiment of the present invention.

FIG. 10 is a diagram showing that the display of the road information guide unit changes in response to the lighting of the traffic light in FIG. 9.

### DETAILED DESCRIPTION OF THE EMBODIMENTS

While the present invention may be modified in various ways and take on various alternative forms, specific embodiments thereof are shown in the drawings and described in detail below. However, it should be understood that there is no intent to limit the present invention to the particular forms disclosed, but on the contrary, the present invention covers all modifications, equivalents, and alternatives falling within the spirit and scope of the present invention.

Hereinafter, a traffic signal system 1 according to preferred embodiments of the present invention will be described in detail with reference to the accompanying drawings.

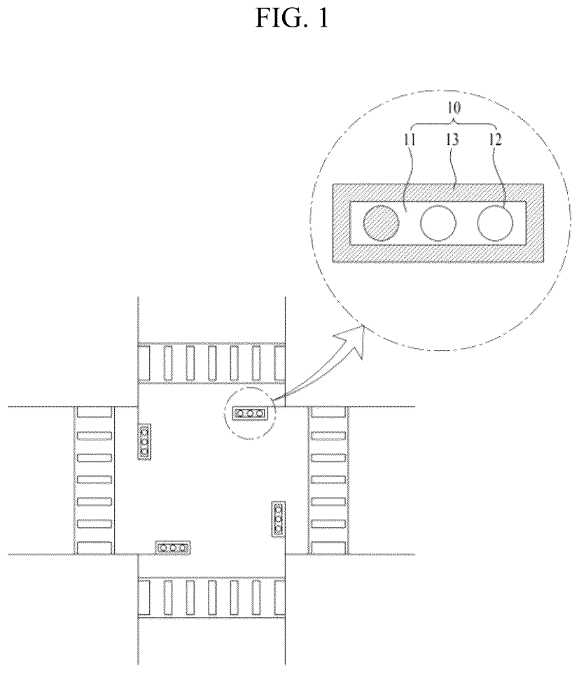

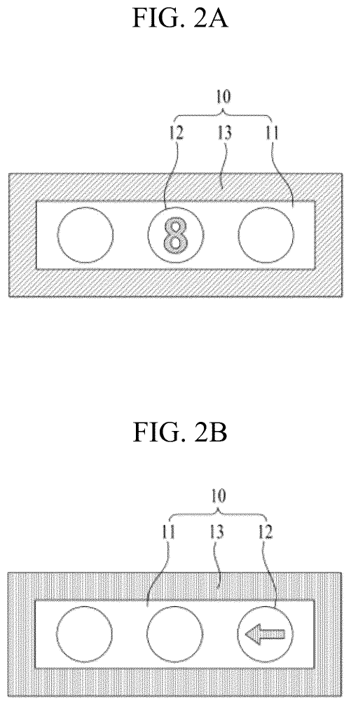

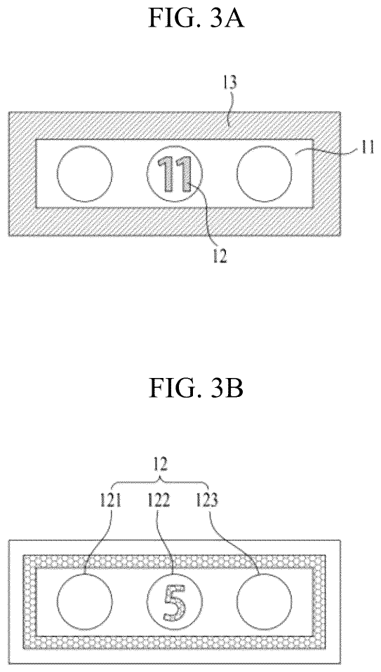

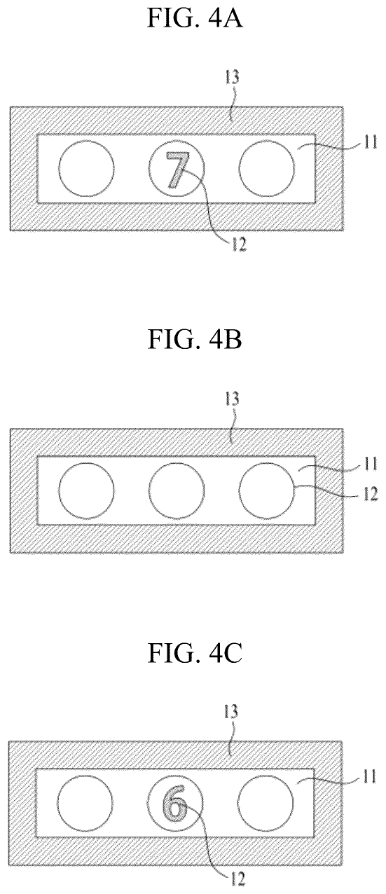

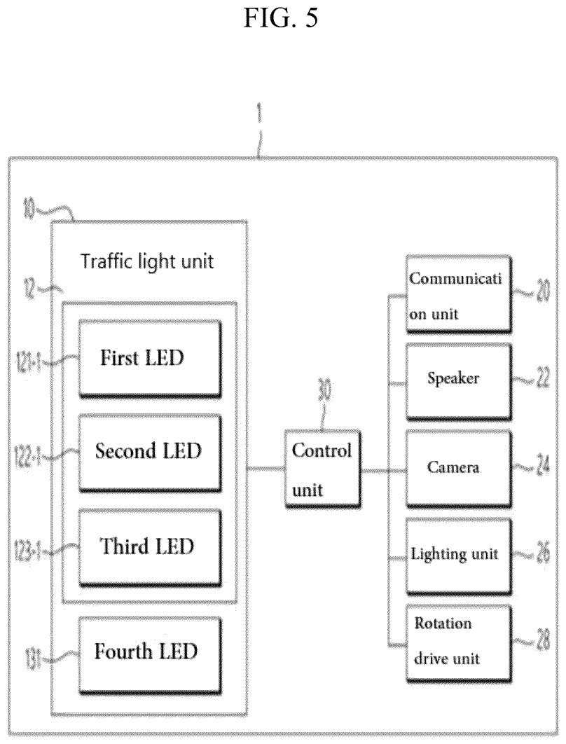

FIG. 1 is an exemplary diagram of a traffic signal system 1 according to the present invention, FIGS. 2A-2B are exemplary diagram of an embodiment of the signal auxiliary lighting unit 13, FIGS. 3A-3B are exemplary diagram of changing the color and size of the signal auxiliary lighting unit 13 depending on the remaining time, FIGS. 4A-4C are exemplary operation diagram of the signal auxiliary lighting unit 13 in response to the remaining time change, and FIG. 5 is a control block diagram of the traffic signal system 1.

The configuration of the traffic signal system 1 will be described with reference to FIGS. 1 to 5.

The traffic signal system 1 includes a traffic light unit 10, a communication unit 20, a speaker 22, a camera 24, a lighting unit 26, a rotation drive unit 28, and a control unit 30.

The traffic light unit 10 provides signals for vehicle operation and pedestrian crossing walking to drivers operating vehicles and pedestrians walking on the sidewalk. The traffic light unit 10 may include a traffic light support body 11, a traffic light 12, and a traffic light auxiliary lighting unit 13.

The traffic light support body 11 supports the traffic light 12. The traffic light support body 11 has a shape that supports the traffic light while being supported by the traffic light support pole.

The traffic light 12 is composed of a plurality of LEDs that display signals related to the operation of vehicles. The traffic light 12 may include a red traffic light 121, a green traffic light 122, and a direction signal light 123. That is, a red traffic light 121, a green traffic light 122, a yellow traffic light, and a direction signal light 123 may all be provided inside one traffic light support body 11.

The red traffic light 121 provides a signal for a stop instruction. The red traffic light 121 may have a plurality of first LEDs 121-1 that output red color arranged in the traffic light area. All of the plurality of first LEDs 121-1 in the entire area may be turned on or off, or only some of the first LEDs 121-1 may be turned on, or only some of the plurality of first LEDs 121-1 may be turned on. Although limited to a plurality of first LEDs 121-1, they are provided so as to realize various colors.

The green traffic light 122 provides signals for vehicle operation and pedestrian crossing walking. A plurality of second LEDs 122-1 that output green may be arranged in the traffic light area. All of the plurality of second LEDs 122-1 in the entire area may be turned on or off, or only some of the plurality of second LEDs 122-1 may be turned on. Although limited to a plurality of second LEDs 122-1, they are provided so as to realize various colors.

The direction signal light 123 provides a signal for switching the left turn direction of a vehicle at an intersection. A plurality of third LEDs 123-1 are arranged in the traffic light area, and some of the plurality of third LEDs 123-1 can be turned on to display the direction and remaining time. The plurality of third LEDs 123-1 in the traffic light area can be provided to realize various colors, and can be turned on or off to display various shapes of signs, signposts, pictures, etc.

The traffic light auxiliary lighting unit 13 is arranged at the border edge (boundary) area of the traffic light support body 11 and outputs a plurality of colored lights. A plurality of fourth LEDs 131 that output a plurality of colors may be arranged in the border edge area of the traffic light support body 11. All of the plurality of fourth LEDs 131 in the border edge area of the traffic light support body 11 may be turned on or off, or only some of the plurality of fourth LEDs 131 may be turned on. Although limited to a plurality of fourth LEDs 131, they are provided so as to realize various colors.

The communication unit 20 can transmit signal-related data to the central control center or to the outside. The communication unit 20 can perform wireless communication, wherein the wireless communication includes at least one of infrared communication, RF, ZigBee, and Bluetooth. The communication unit 20 receives the video signal and transmits it to the control unit 30, which will be described below, and can be implemented in various ways in response to the standard of the video signal to be received and the implementation type of the user terminal. For example, the communication unit 20 can wirelessly receive an RF (radio frequency) signal transmitted from a broadcasting station (not shown), or can receive video signals by wire based on composite video, component video, super video, SCART, and HDMI (high definition multimedia interface) standards. When the video signal is a broadcast signal, the communication unit 20 may include a tuner that tunes the broadcast signal for each channel.

The communication unit 30 may communicate with other nearby traffic light units or receive road traffic information from public institutions.

The speaker 22 can output sound at a predetermined volume to the sidewalk area and the roadway area. The speaker 22 may be provided so as to adjust the volume of the sound, or may be provided so as to transmit sound only to an arbitrary narrow area, or may be arranged so as to transmit sound over a wide area.

The camera 24 can photograph the front of the traffic light support body 11. The camera 24 photographs the sidewalk area including the crossing waiting area where pedestrians wait to cross the crosswalk, and the roadway area including the crosswalk area and the waiting area for vehicles waiting to pass the crosswalk. The camera 24 is supported by the traffic light support body 11 and can take pictures. The camera 24 may be installed for each traffic light support body 11.

The lighting unit 26 can output light at a predetermined light intensity to the sidewalk area and the roadway area. The lighting unit 26 is preferably provided so as to output light with a greater intensity than that of an ordinary street light. The lighting unit 26 can output light in a highlighted manner or in a concentrated manner, or can be turned on and off freely. The lighting unit 26 may be rotatably supported on the traffic light support body 11.

The lighting unit 26 may include a plurality of filters, and may allow a lighting light to pass through at least one filter and be output. The plurality of filters can be provided so that messages can be projected onto the roadway and transmitted in the form of texts, pictures, etc. to drivers driving on the roadway. For example, it may be a phrase that says “Stop!” and a picture that could emphasize pedestrians, and the like.

The rotation drive unit 28 drives the lighting unit 26 to rotate relative to the traffic light support body 11. The rotation drive unit 28 is composed of a rotation motor, a turntable, etc., and can enable the lighting unit 26 to output light in various directions.

The control unit 30 controls a plurality of LEDs to turn on according to the signal control signal for the traffic light 12, and controls the signal auxiliary lighting unit 13 so that the same color as that of the traffic light 12 is output. The control unit 30 may store control setting information including the display time for the traffic light 12, and can control the plurality of LEDs so that when the signal lamp 12 is turned on, the remaining time of the signal display time is displayed according to the signal display time of the control setting information.

The control unit 30 may control such that at least one of the remaining time displayed, the color and the size of the signal auxiliary lighting unit 13 is changed as the remaining time displayed in the traffic light 12 area decreases.

The control unit 30 can control the output of the signal auxiliary lighting unit 13 to flicker light when the remaining time displayed in the area of the traffic light 12 decreases and the remaining time displayed changes.

The control unit 30 may set the light intensity of the signal auxiliary lighting unit 13 to be at least stronger than the light intensity of the traffic light 12. FIGS. 2A-2B are exemplary diagram of an embodiment of the signal auxiliary lighting unit 13.

In FIG. 2A, if the remaining time of the signal is displayed on the traffic light and the color of the remaining time is green, the color of the signal auxiliary lighting unit 13 is also displayed in the same green color.

In FIG. 2B, the direction signal light 123 among the traffic lights 12 is turned on, the direction signal light 123 is turned on in green, and the color of the signal auxiliary lighting unit 13 is also displayed in the same green.

FIGS. 3A-3B are exemplary diagram of changing the color and size of the signal auxiliary lighting unit 13 depending on the remaining time.

In FIG. 3A, the remaining time displayed in the area of the green traffic light 122 is decreasing to 11, and the color of the signal auxiliary lighting unit 13 can be displayed by changing from green to yellow. The color of the remaining time displayed in the green traffic light 122 area may change from green to yellow and red over time.

In FIG. 3B, the remaining time displayed in the green traffic light 122 area is decreasing to 5, and the size of the light output area may be reduced so that only the inner area of the signal auxiliary lighting unit 13 outputs light.

FIGS. 4A-4C are exemplary operation diagram of the signal auxiliary lighting unit 13 in response to the remaining time change

In FIG. 4A, the remaining time displayed in the green traffic light 122 area is displayed as 7 seconds, and the color of the signal auxiliary lighting area 13 is also displayed in the same green.

In FIG. 4B, the remaining time displayed in the green traffic light 122 area is turned off to change from 7 seconds to 6 seconds, and the signal auxiliary lighting area 13 is also turned off in the same manner.

In FIG. 4C, the remaining time displayed in the green traffic light 122 area is changed and displayed from 7 seconds to 6 seconds, and the color of the signal auxiliary lighting area 13 is also displayed in the same green.

Thereby, when the remaining time displayed in the traffic light area decreases and the displayed remaining time changes, the output of the signal auxiliary lighting unit 13 is controlled to flicker light.

Modifiable embodiments other than the above-described embodiments will be described.

The control unit 30 stores traffic light setting information including the display time for the traffic light unit 10. If the traffic light 12 starts to be displayed, the plurality of LEDs of the traffic light 12 can be controlled so as to display the remaining time in seconds among the display time of the traffic light 12 based on the traffic light display time of the traffic light setting information.

The control unit 30 may control the speaker 22 so as to output the remaining traffic light time as a voice in response to displaying the remaining time in seconds among the display times of the traffic light 12.

The control unit 30 sets the remaining time among the display times of the traffic light 12, controls the camera 24 so as to photograph the front of the traffic light support body 11 when the set remaining time is reached, and may store the photographed image of the front of the traffic light support body 11.

If it is determined that there is a scene that is determined to be an accident among the stored images of the front of the traffic light support body 11, the control unit 30 can control so as to transmit the stored image of the front of the traffic light support body 11 to public institutions including police stations.

If it is determined that there is no scene that is determined to be an accident among the stored images of the front of the traffic light support body 11, the control unit 30 may control so that the image is deleted after a predetermined period of time.

It may further include an alarm unit that provides a warning message to pedestrians or vehicle drivers. The alarm unit may use a traffic light 12, or may be provided with lights, speakers or the like so as to be able to warn pedestrians or vehicle drivers about events occurring in the crosswalk and surrounding areas.

The control unit stores control setting information including the blinking time for each of the plurality of traffic lights 12, and turns on at least one traffic light among a plurality of traffic lights based on the stored control setting information. If the traffic light turns on for a preset time, the plurality of LEDs can be controlled so as to display the remaining time.

The control unit can control the display light to display the remaining time if a signal corresponding to the traffic light is displayed in the area of the traffic light.

The control unit may display the remaining time in the area of the traffic light when the preset time has passed since the relevant traffic light is turned on, and may control the auxiliary traffic light to display a signal corresponding to the traffic light.

The control unit can control the remaining time to be displayed in the area of the traffic light along with a signal corresponding to the traffic light when a preset time has passed since the corresponding traffic light is turned on.

The control unit can control a first LED, a second LED, a third LED, and a fourth LED that are uniformly distributed in the traffic light area of the red traffic light, the green traffic light, and the direction signal light. The control unit can change the ratio of at least some of the content areas displayed in the traffic light area, may delete at least some areas, and may change the location of at least some areas.

The control unit may determine the current supply status, voltage, and resistance of the first LED, the second LED, the third LED, and the fourth LED that are uniformly distributed in the traffic light area of the red traffic light, the green traffic light, and the direction signal light, thereby determining the defective LED area. Thereby, the control unit can determine the displayable area of the content and control the content to be displayed in the displayable area of the content.

The control unit can warn the driver of the vehicle by blinking the red LED of an adjacent traffic light when the remaining time is shortened to a set time. In addition, the LED that displays the traffic light and remaining time can also blink to prevent vehicles from entering the intersection. At the same time, a voice can also be output through the speaker to guide people to avoid entering the intersection.

The lighting unit may also be used to form a lighting curtain to prevent entry into an intersection.

The control unit may set a limit time out of the remaining time, and control a plurality of LEDs so as to display an entry prohibition phrase in the signal display area of the traffic light 12 when the limit time remains.

As the remaining time decreases, the control unit may increase the brightness, including the luminance and brightness, of the plurality of LEDs in the display area of the signal display area of the traffic light 12.

Due to the above traffic signal system 1, the traffic light auxiliary lighting unit is installed in the border edge area of the traffic light support body to allow the color of the signal auxiliary lighting unit to be output similarly to the color of the traffic light, thereby serving to prevent it from being covered by sun or light, improve visibility, prevent traffic accidents and safety accidents, and finally improve user safety.

In addition, the remaining time of the signal is displayed in a state in which visibility is improved by the traffic light auxiliary lighting unit, so that the user can see the remaining time and drive and walk safely, and user visibility can be further improved by changing at least one of the color and size of the displayed remaining time. In addition, when the remaining time changes, the traffic light auxiliary lighting unit can also blink to increase visibility. By setting the light intensity of the signal auxiliary lighting unit to be stronger than that of the traffic light, the visibility of the user who sees it can be further increased.

Next, the guidance display function of the traffic light auxiliary lighting unit 13 will be described as another embodiment of the present invention.

The traffic light unit 10 includes a traffic light support body 11, a traffic light 12, and a traffic light auxiliary lighting unit 13. Among the traffic light auxiliary lighting units 13, the fourth LED 131 mounted on the upper border of the traffic light support body 11 is configured to blink and display a predetermined guide mark. The fourth LED 131 forms a grid shape in which point light sources are closely arranged at predetermined intervals, and only some of the LEDs may emit light under the control of a control unit to display a specific mark or signal.

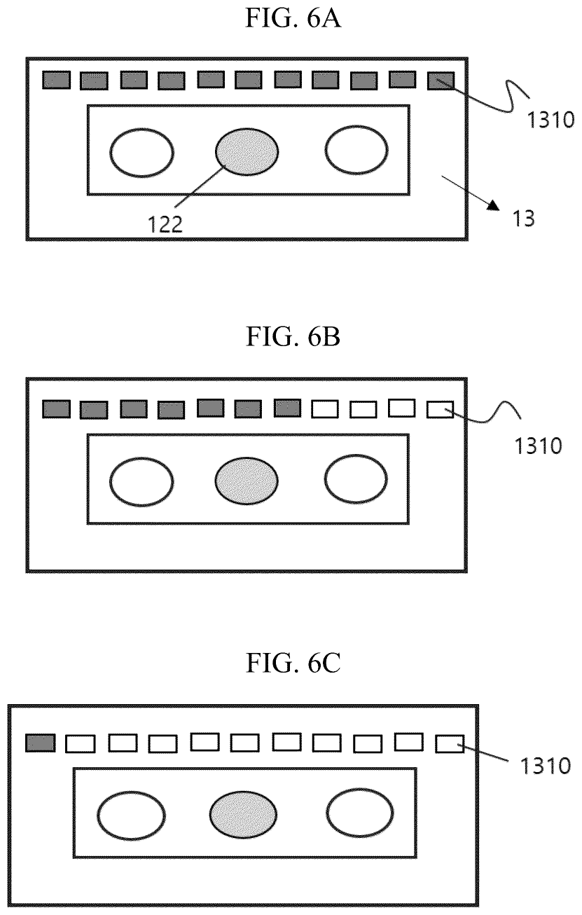

For example, in FIGS. 6A-6C, the fourth LED 131 displays a quadrangular mark 1310. The quadrangular mark 1310 is displayed by turning on the LED forming a square outline among the fourth LEDs 131 and the LED inside the outline when the green traffic light 122 emits light. In the lighting method, all of the marks 1310 are lid at first, and as time passes, the lit marks 1310 are turned off one by one, and at the end, all the marks 1310 are turned off.

FIG. 6A shows a state in which the traffic light auxiliary lighting unit 13 on the upper edge lights up all LEDs forming the square mark 1310. At this time, it is the moment when the green traffic light 122 is turned on, and the vehicle or pedestrian is allowed to drive or walk through the mark 1310, indicating that there is sufficient time.

FIG. 6B shows a state in which the traffic light auxiliary lighting unit 13 on the upper edge lights up about half of the LEDs forming the square mark 1310. If the lighting time of the green traffic light 122 of the crosswalk is 30 seconds, about half of the square marks 1310 are lit in about 15 seconds. If the lighting time of the green traffic light 122 on the travelling road is 3 minutes, about half of the square mark 1310 lights up in about 1 minute and 30 seconds.

FIG. 6C shows a state in which the LED forming the square mark 1310 of the traffic light auxiliary lighting unit 13 on the upper edge is almost turned off and only one remains. Drivers and pedestrians can recognize that the signal will soon stop, and may stop driving or walking to ensure safety.

In the present invention, the reason that the square mark 1310 is linked to the green traffic light 122 is because the green traffic light indicates steady driving or moving straight on a crosswalk, and thus a familiar shape without direction is more appropriate than a mark indicating the direction. Therefore, the mark 1310 can use a circle or ellipse in addition to a square. Similarly to the previous embodiment, the mark 1310 is preferably displayed in a darker or brighter color than the traffic light.

In addition, it is preferable that the color of the mark 1310 lights up in the same green color as the green traffic light 122 to prevent confusion among drivers and pedestrians as much as possible. In addition to being arranged in a row at the upper part, the marks 1310 can be changed in various ways, such as being arranged at the bottom, or both above and below.

Next, the traffic light auxiliary lighting unit 13 of the present invention can display a direction mark 1310 so as to inform the remaining time when turning left or right, especially when installed on driving roads for motor vehicles. As an example of the direction mark 1310, “<” shapes indicating a left turn may be arranged in a row, or shapes indicating a right turn may be arranged in a row.

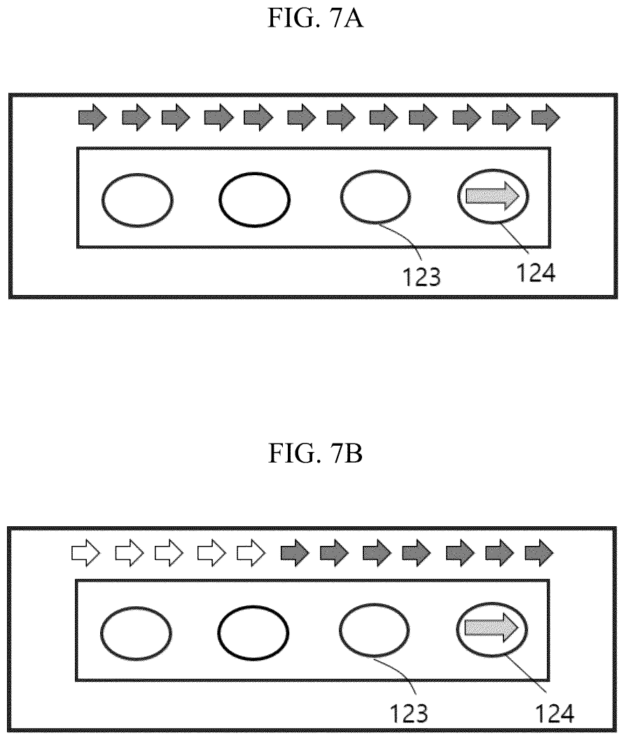

FIGS. 7A-7B further includes a right turn traffic light 124 in addition to the previous embodiments. In FIGS. 7A-7B, the fourth LED 131 displays an arrow-shaped mark 1310 whose apex is on the right side. The arrow-shaped mark 1310 is displayed by lighting up the LED forming the arrow outline among the fourth LEDs 131 and the LED inside the outline, when the right turn signal light 124 emits light. In the lighting method, all the marks 1310 are lit at first (FIG. 7A), and as time passes, the lit marks 1310 are turned off one by one (FIG. 7B), and finally, all the marks 1310 are turned off.

Recently, according to the revision of road traffic laws, it is stipulated that when the vehicle turns right, temporary stop makes mandatory while the crosswalk is green or a pedestrian is walking on the crosswalk. The control unit of the present invention does not start lighting the right turn signal light 124 and the fourth LED 131, if the presence of a passerby in the crosswalk area is detected through the camera 24, or if it is received through the communication unit 20 that another traffic light at the right turn intersection has switched to a green traffic light. In addition, if an event like the one described above occurs even while the light is being emitted, a light-off signal is transmitted and the light is switched to the light-off state.

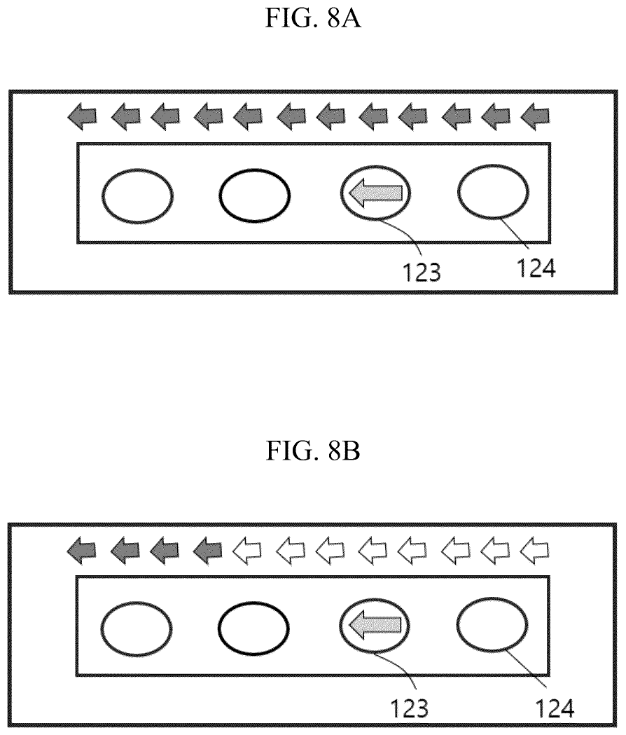

FIGS. 8A-8B illustrates an embodiment in which in the same right turn traffic light 124 as shown in FIGS. 7A-7B, the fourth LED 131 displays an arrow-shaped mark 1310 with the apex on the left in relation to the left turn traffic light 123, and all of the marks 1310 light up at first (FIG. 8A), and as time passes, the lighted marks 1310 turn off one by one (FIG. 8B).

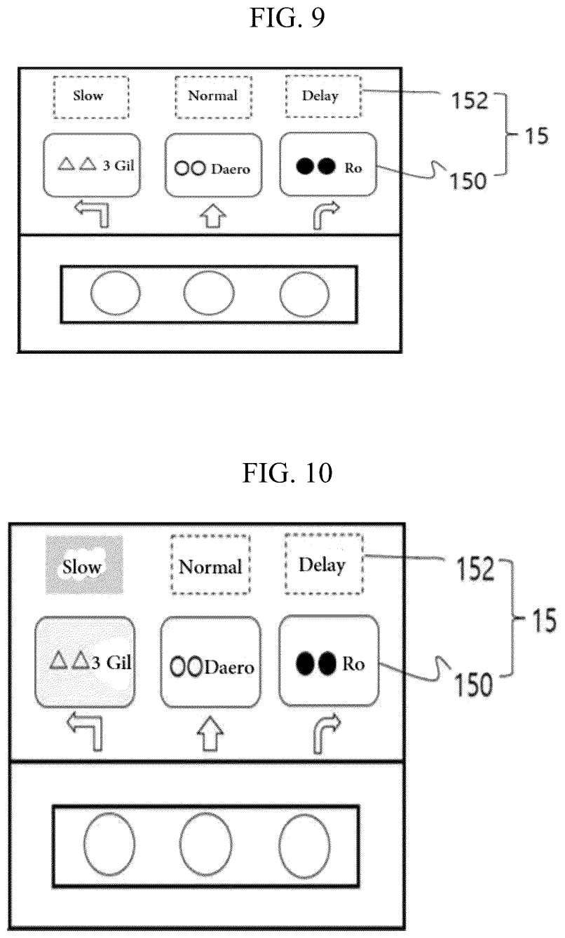

FIG. 9 shows another embodiment of the present invention, in which the traffic light unit 10 further includes a road information guide unit 15 on an upper side of the traffic light auxiliary lighting unit 13. The road information guide unit 15 includes a road name address guide unit 150 and a road condition notification unit 152.

Currently, in South Korea road name addresses are used as obligatory since 2014. Depending on the size of the road, names are given as “Road” (e.g. Gangnam-Daero), “Ro” (e.g. Tehran 10-Ro), and “Street” (e.g. Duru-Gil), and the number of 1, 2, 3, . . . is added from the location of each road. However, many people are experiencing inconvenience due to various problems, for example, people have become accustomed to using street number addresses over the years, the use of road name addresses has not spread widely, road guidance is not sufficient, and text fonts are small.

Therefore, as shown in FIG. 9, the present invention displays the road name for a straight road, the road name when driving on the left, and the road name when driving on the right, and particularly supports route guidance for drivers and pedestrians. Currently, road name and address signs are installed in many places, however, there is a disadvantage in that visibility and consistent guidance are insufficient, and if the road name address is changed or disappeared, the maintenance costs are also high. However, when the road name address guide unit 150 of the present invention is used, the visibility is excellent and thus, the road name address can be recognized more reliably and clearly, and even if there is a change in the road name address, it can be easily corrected. In the embodiments of FIG. 9, it is explained that one road name address is displayed, however, if necessary, for example, major road name addresses that the vehicle passes when driving straight can be further displayed.

Further, although the simple display of representative road names has been taken as an example, the road name address guide unit 150 can further display major buildings in the corresponding section. Current road signboards often display major institutions or facilities (e.g. City Hall, Gwanghwamun) that are far away from the current location, which are almost useless for driving. Rather, it can solve the problem of inconvenience caused by the names of major nearby buildings not being displayed. Furthermore, the government and local governments will be able to manage and operate major institutions and facilities included in the road name addresses in a way that is appropriate for the current road name address.

The road condition notification unit 152 is installed adjacent to each road name address guide unit 150, so that when going straight, turning left, or turning right, it is displayed in text whether the section of the corresponding road name address is under “normal,” “slow (slight delay),” or “congested” conditions. The control unit 30 receives road traffic conditions in real time through the communication unit 20 and displays congestion information. This type of guidance can be expected to have an auxiliary effect that allows the user to recognize not only the congestion status of the road but also the road name address.

In addition, when a traffic light in a specific direction lights up as shown in FIG. 10, the present invention can highlight the road information guide unit 15 in the same color as the traffic light, or place flashing notice to improve visibility for drivers and pedestrians.

Although the preferred embodiments of the present invention have been described above, it would be obvious that various changes and modifications can be made to the present invention and that the scope of rights of the present invention extends to areas that are the same as or equivalent to the claims described below.

1. A traffic signal system comprising:
a traffic light unit that includes a traffic light consisting of a plurality of LEDs that display signals for vehicle operation, a traffic light support body that supports the traffic light, and a signal auxiliary lighting unit that is disposed in a boundary edge area of the traffic light support body and outputs a plurality of colored lights; and
a control unit that controls a plurality of LEDs to turn on in response to signal control signals for traffic lights and controls the signal auxiliary lighting unit so as to output the same color as the traffic light,
wherein the LED mounted on an upper border or a lower border of the traffic light support body is configured to light up and display a predetermined guide mark,
wherein the control unit stores control setting information including a display time for the traffic light, and lights up a guide mark on the traffic light support body in response to the signal display time of the control setting information if the traffic light is turned on, the control unit controls so that:
if a green traffic light emits, all of the guide marks light up by arranging square or circular shapes in a line, and the number of lighting of the square or circular shapes decreases as the display time decreases, and
if a left turn signal light emits, all of the guide marks light up by arranging arrow shapes with the vertex on the left in a line, and the number of lighting of the arrow shapes decreases as the display time decreases.

2. The traffic signal system according to claim 1, wherein:
the traffic light further comprises a right turn signal light, and
the control unit controls so that when the right turn signal light emits, all of the guide marks light up by arranging arrow shapes with the vertex on the right side in a line, and the number of lighting of the arrow shapes decreases as the display time decreases.

3. The traffic signal system according to claim 2, wherein:
the control unit does not start lighting the right turn signal light and the LED of the traffic light auxiliary lighting unit, if the presence of a passerby in a crosswalk area is detected, or if it is received through a communication unit that another traffic light at the right turn intersection has switched to a green traffic light.

4. The traffic signal system according to claim 1, wherein:
a road information guide unit is further included on an upper side or a lower side of the traffic light auxiliary lighting unit, wherein the road information guide unit includes a road name address guide unit and a road condition notification unit.

5. The traffic signal system according to claim 4, wherein:
the road name address guide unit displays a road name for a straight road, a road name when driving on the left, and a road name when driving on the right, wherein the road name is a road name under the Korean Road Traffic Act of “Daero”, “Ro”, or “Gil”.

6. The traffic signal system according to claim 5, wherein:
the road name address guide unit further displays buildings included in the road name address of the straight, left, or right driving section.

7. The traffic signal system according to claim 5, wherein:
the road condition notification unit is installed adjacent to each road name address guide unit, so that when going straight, turning left, or turning right, it is displayed in text whether the section of the corresponding road name address is under “normal,” “slight delay,” or “congested” conditions, and the control unit receives road traffic conditions in real time through the communication unit the traffic signal system and displays congestion information.
